(19) United States
(12) Patent Application Publication
(10) Pub. No.: US 2026/0155306 A1
(43) Pub. Date: Jun. 4, 2026

(54) MULTILAYER CERAMIC CAPACITOR

(71) Applicant: SAMSUNG ELECTRO-MECHANICS CO., LTD., Suwon-si (KR)

(72) Inventors: Hyejin PARK, Suwon-si (KR); Yu Jin SO, Suwon-si (KR); Eunseol BAE, Suwon-si (KR); Byungwoo KANG, Suwon-si (KR); Seung-Hun HAN, Suwon-si (KR); Jungmin KIM, Suwon-si (KR); Hongseok KIM, Suwon-si (KR)

(73) Assignee: SAMSUNG ELECTRO-MECHANICS CO., LTD., Suwon-si (KR)

(21) Appl. No.: 19/078,515

(22) Filed: Mar. 13, 2025

(30) Foreign Application Priority Data
Nov. 29, 2024 (KR) 10-2024-0174629

(51) Int. Cl. H01G 4/232; H01G 4/30

(52) U.S. Cl. CPC H01G 4/2325; H01G 4/30

(57) ABSTRACT

A multilayer ceramic capacitor includes a body and an external electrode. The body includes a first surface and a second surface opposite each other in a first direction, a plurality of dielectric layers and a plurality of internal electrodes. The body also includes a first cover layer disposed at an outermost side in the first direction, and a second cover layer disposed at an outermost side in a second direction intersecting the first direction. The second cover layer has an average thickness greater than an average thickness of the first cover layer. The external electrode is disposed outside the body and connected to the plurality of internal electrodes.

### CROSS-REFERENCE TO RELATED APPLICATION

This application claims priority to and the benefit of Korean Patent Application No. 10-2024-0174629 filed at the Korean Intellectual Property Office on Nov. 29, 2024, the entire contents of which are incorporated herein by reference.

### BACKGROUND

### (a) Field

The present disclosure relates to a multilayer ceramic capacitor.

### (b) Description of the Related Art

Electronic components using ceramic materials include capacitors, inductors, piezoelectric elements, varistors, or thermistors. Among such ceramic electronic components, a multilayer ceramic capacitor (MLCC) may be used in various electronic devices due to its small size, high capacity, and easy mounting.

A body of the multilayer ceramic capacitor includes a plurality of dielectric layers and a plurality of internal electrodes disposed between the dielectric layers. The dielectric layers are piezoelectric, and thus when a DC or AC voltage is applied to the multilayer ceramic capacitor, a piezoelectric phenomenon occurs between the internal electrodes, thereby generating periodic vibrations while expanding and contracting the volume of the body depending on a frequency.

These vibrations may be transmitted to a substrate through external electrodes and a solder connecting the external electrodes and the substrate, and the substrate may generate a vibration sound. Such a vibration sound may correspond to an audible frequency range of 20 Hz to 20,000 Hz, which is uncomfortable for people, and the 1 vibration sound at this time is called acoustic noise.

In some cases, the external electrode includes an electrode layer and a conductive resin layer covering it, and even in such structures, a technique that can reduce acoustic noise is required.

### SUMMARY

One aspect of an embodiment attempts to provide a multilayer ceramic capacitor capable of reducing acoustic noise.

However, the problem to be solved by the embodiments of the present disclosure is not limited to the above-described problems, and can be variously extended within the scope of the technical spirit included in the present disclosure.

An embodiment of the present disclosure provides a multilayer ceramic capacitor including: a body comprising a first surface and a second surface opposite each other in a first direction, a plurality of dielectric layers and a plurality of internal electrodes, a first cover layer disposed at an outermost side in the first direction, and a second cover layer disposed opposite the first cover layer in the first direction and having an average thickness that is greater than an average thickness of the first cover layer, and an external include a disposed outside the body and connected to the plurality of internal electrodes, wherein the external electrode includes a connection portion connected to the plurality of internal electrodes in a second direction different from the first direction, a first band portion connected to the connection portion and covering a portion of the first surface, a second band portion connected to the connection portion and covering a portion of the second surface, a first conductive resin layer is disposed on the first band portion, a second conductive resin layer disposed on the second band portion, and a plating layer connected to the connection portion and covering the first conductive resin layer and the second conductive resin layer.

The multilayer ceramic capacitor may further include an insulating resin layer covering a portion of the second surface of the body.

The insulating resin layer may cover a portion of the second band portion, and the second conductive resin layer may cover a portion of the insulating resin layer.

The insulating resin layer may include epoxy, urethane, silicon oxide (SiO₂) or titanium oxide (TiO).

The plurality of dielectric layers and the plurality of internal electrodes may be stacked in the first direction.

The plurality of dielectric layers and the plurality of internal electrodes may be stacked in a third direction different from both the first direction and the second direction.

The first conductive resin layer and the second conductive resin layer may each include a metal and a resin.

An embodiment of the present disclosure provides a multilayer ceramic capacitor including: a body comprising a first surface and a second surface opposite each other in a first direction, a plurality of dielectric layers and a plurality of internal electrodes, an external electrode disposed outside the body and connected to the plurality of internal electrodes, and an interposer connected to the external electrode on a second surface side of the body, wherein the external electrode includes a connection portion connected to the internal electrodes in a second direction different from the first direction, a first band portion connected to the connection portion and covering a portion of the first surface, a second band portion connected to the connection portion and covering a portion of the second surface, a first conductive resin layer disposed on the first band portion, a second conductive resin layer disposed on the second band portion, and a plating layer connected to the connection portion and covering the first conductive resin layer and the second conductive resin layer.

The interposer may include an interposer body, and a connection electrode disposed outside the interposer body and connected to the external electrode.

The interposer body may include an insulating material.

The interposer body may include a first main surface opposing the second surface of the body, and a second main surface disposed opposite the first main surface in the first direction, and the connection electrode may include a joint portion disposed on the first main surface.

The connection electrode may include a mounting portion disposed on the second main surface.

The connection electrode may include an interconnecting portion connecting the joint portion and the mounting portion.

The multilayer ceramic capacitor may further include an insulating resin layer covering a portion of the second surface of the body.

The insulating resin layer may be spaced apart from the interposer.

The insulating resin layer may include epoxy, urethane, silicon oxide (SiO₂) or titanium oxide (TiO).

The plurality of dielectric layers and the plurality of internal electrodes may be stacked in the first direction.

The plurality of dielectric layers and the plurality of internal electrodes may be stacked in a third direction different from both the first direction and the second direction.

An embodiment of the present disclosure provides a multilayer ceramic capacitor including: a body comprising a first surface and a second surface opposite each other in a first direction, a plurality of dielectric layers and a plurality of internal electrodes, an external electrode disposed outside the body and connected to the plurality of internal electrodes, and a bump electrode connected to the external electrode on a second surface side of the body, wherein the external electrode includes a connection portion connected to the plurality of internal electrodes in a second direction different from the first direction, a first band portion connected to the connection portion and covering a portion of the first surface, a second band portion connected to the connection portion and covering a portion of the second surface, a first conductive resin layer disposed on the first band portion, a second conductive resin layer disposed on the second band portion, and a plating layer connected to the connection portion and covering the first conductive resin layer and the second conductive resin layer.

The body may include a third surface and a fourth surface opposite each other in the second direction, the external electrode may include a first external electrode connected to the plurality of internal electrodes on the third surface and a second external electrode connected to the plurality of internal electrodes on the fourth surface, and the bump electrode may include a first bump electrode connected to the first external electrode, and a second bump electrode spaced apart from the first bump electrode in the second direction and connected to the second external electrode.

The bump electrode may include a bump body and a conductive layer disposed on a surface of the bump body and connected to the external electrode.

The bump body may include a metal or an insulating material.

The multilayer ceramic capacitor may further include an insulating resin layer covering a portion of the second surface of the body.

The plurality of dielectric layers and the plurality of internal electrodes may be stacked in the first direction.

The plurality of dielectric layers and the plurality of internal electrodes may be stacked in a third direction different from both the first direction and the second direction.

In accordance with the multilayer ceramic capacitor according to an embodiment, acoustic noise may be reduced.

### BRIEF DESCRIPTION OF THE DRAWINGS

FIG. 1 illustrates a schematic perspective view showing a multilayer ceramic capacitor according to an embodiment.

FIG. 2 illustrates an exploded perspective view schematically showing a stack structure of the internal electrodes of the multilayer ceramic capacitor of FIG. 1.

FIG. 3 illustrates a top plan view schematically showing a first internal electrode of the multilayer ceramic capacitor of FIG. 1.

FIG. 4 illustrates a plan view schematically showing a second internal electrode of the multilayer ceramic capacitor of FIG. 1.

FIG. 5 illustrates a cross-sectional view taken along line I-I′ of FIG. 1.

FIG. 6 illustrates a cross-sectional view taken along line II-II′ of FIG. 1.

FIG. 7 illustrates a cross-sectional view taken along line III-III′ of FIG. 1.

FIG. 8 illustrates a cross-sectional view schematically showing the multilayer ceramic capacitor of FIG. 1 mounted on a circuit board.

FIG. 9 illustrates a perspective view schematically showing a modified example of FIG. 1.

FIG. 10 illustrates schematic cross-sectional view of FIG. 9.

FIG. 11 illustrates a schematic perspective view showing a multilayer ceramic capacitor according to another embodiment.

FIG. 12 illustrates a cross-sectional view taken along line IV-IV′ of FIG. 11.

FIG. 13 illustrates a cross-sectional view schematically showing the multilayer ceramic capacitor of FIG. 11 mounted on a circuit board.

FIG. 14 illustrates a perspective view schematically showing a modified example of FIG. 13.

FIG. 15 illustrates a schematic cross-sectional view of FIG. 14.

FIG. 16 illustrates a schematic perspective view showing a multilayer ceramic capacitor according to another embodiment.

FIG. 17 illustrates a cross-sectional view taken along line V-V′ of FIG. 16.

FIG. 18 illustrates a bottom view of FIG. 16.

FIG. 19 illustrates a cross-sectional view schematically showing the multilayer ceramic capacitor of FIG. 16 mounted on a circuit board.

FIG. 20 illustrates a bottom view schematically showing a modified example of FIG. 16.

FIG. 21 illustrates a perspective view schematically showing a modified example of FIG. 16.

FIG. 22 illustrates schematic cross-sectional view of FIG. 21.

FIG. 23 illustrates a schematic perspective view showing a multilayer ceramic capacitor according to another embodiment.

FIG. 24 illustrates a cross-sectional view taken along line VI-VI′ of FIG. 23.

FIG. 25 illustrates a perspective view schematically showing a modified example of FIG. 23.

FIG. 26 illustrates a perspective view schematically showing a modified example of FIG. 23.

FIG. 27 illustrates schematic cross-sectional view of FIG. 26.

FIG. 28 illustrates a schematic cross-sectional view showing a multilayer ceramic capacitor according to another embodiment.

FIG. 29 illustrates a cross-sectional view schematically showing a modified example of FIG. 28.

FIG. 30 illustrates a cross-sectional view schematically showing a modified example of FIG. 28.

FIG. 31 illustrates a schematic cross-sectional view showing a multilayer ceramic capacitor according to another embodiment.

FIG. 32 illustrates a cross-sectional view schematically showing a modified example of FIG. 31.

### DETAILED DESCRIPTION

Hereinafter, various embodiment of the present disclosure will be described in detail so that a person of ordinary skill in the technical field to which the present disclosure belongs can easily implement it with reference to the accompanying drawings. The drawings and description are to be regarded as illustrative in nature and not restrictive. Like reference numerals designate like elements throughout the specification. In addition, some components in the accompanying drawings are exaggerated, omitted, or schematically illustrated, and the size of each component does not fully reflect the actual size.

The accompanying drawings are provided only in order to allow embodiments disclosed in the present specification to be easily understood and are not to be interpreted as limiting the spirit disclosed in the present specification, and it is to be understood that the present invention includes all modifications, equivalents, and substitutions without departing from the scope and spirit of the present invention.

Terms including ordinal numbers such as first, second, and the like will be used only to describe various components, and are not to be interpreted as limiting these components. The terms are only used to differentiate one component from other components.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

It will be further understood that terms “comprises/includes” or “have” used throughout the specification specify the presence of stated features, numerals, steps, operations, components, parts, or a combination thereof, but do not preclude the presence or addition of one or more other features, numerals, steps, operations, components, parts, or a combination thereof. Accordingly, unless explicitly described to the contrary, the word “comprise” and variations such as “comprises” or “comprising” will be understood to imply the inclusion of stated components but not the exclusion of any other components.

Further, throughout the specification, the phrase “in a plan view” means when an object portion is viewed from above, and the phrase “in a cross-sectional view” means when a cross-section taken by vertically cutting an object portion is viewed from the side.

In addition, throughout the specification, “connected” means that two or more components are not only directly connected, but two or more components may be connected indirectly through other components, physically connected as well as being electrically connected, or it may be referred to by different names depending on the location or function, but may mean integral.

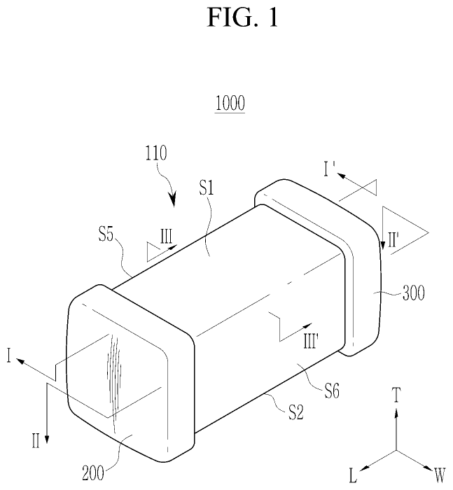

FIG. 1 illustrates a schematic perspective view showing a multilayer ceramic capacitor according to an embodiment.

Referring to FIG. 1, the multilayer ceramic capacitor 1000 according to the present embodiment includes a body 110, a first external electrode 200, and a second external electrode 300.

First, when directions are defined to clearly describe the present embodiment, a T-axis, a L-axis, and a W-axis indicated in the drawings indicate axes representing a first direction, a second direction, and a third direction of the multilayer ceramic capacitor 1000, respectively.

The first direction (T-axis direction) may be a direction that is perpendicular to a certain surface, (e.g., a main surface, a surface substantially perpendicular to a thickness direction) of the sheet-shaped components. For example, the first direction (T-axis direction) may be a direction in which dielectric layers 140 are stacked. Hereinafter, when necessary, the first direction may be described as a “thickness direction.”

The second direction (L-axis direction), which is the direction parallel to the certain surface (e.g., main surfaces) of the sheet-shaped components, may be a direction that differs from (e.g., intersects or is orthogonal to) the thickness direction (T-axis direction). For example, the second direction (L-axis direction) may be a direction in which the first external electrode 200 and the second external electrode 300 oppose each other. Hereinafter, when necessary, the second direction may be described as a “length direction.”

The third direction (W-axis direction), which is a direction parallel to the certain surface (e.g., e.g., main surface) of the sheet-shaped components, may be a direction that differs from (e.g., intersects or is orthogonal to) both the first direction (T-axis direction) and the second direction (L-axis direction). Hereinafter, when necessary, the third direction may be described as a “width direction.”

The body 110 may have a substantially hexahedral shape, but the present embodiment is not limited thereto. Due to shrinkage during sintering, the body 110 may have a substantially hexahedral shape, but not a perfect hexahedral shape. For example, the body 110 has a substantially rectangular parallelepiped shape, but portions corresponding to corners or vertices may each have a rounded shape.

In the present embodiment, for better understanding and ease of description, surfaces opposing each other in the thickness direction (T-axis direction) of the body 110 are defined as a first surface S1 and a second surface S2, surfaces opposing each other in the length direction (L-axis direction) of the body 110 and connecting the first surface S1 and the second surface S2 are defined as a third surface S3 and a fourth surface S4, and surfaces opposing each other in the width direction (W-axis direction) of the body 110 and connecting the first surface S1 and the second surface S2 are defined as a fifth surface S5 and a sixth surface S6.

In an optical microscope or scanning electron microscope (SEM) photograph of the lengthwise (L-axis direction) and thickness-wise (T-axis direction) cross section of the body 110 at the center in the width direction (W-axis direction), the length of the body 110 may refer to the maximum of the lengths of a plurality of line segments, each of which connects two outermost boundary lines of the body 110 facing each other in the length direction (L-axis direction), shown in the above-mentioned cross section photograph, and is parallel with the length direction (L-axis direction). Alternatively, the length of the body 110 may refer to the minimum of the lengths of a plurality of line segments, each of which connects two outermost boundary lines of the body 110 facing each other in the length direction (L-axis direction), shown in the above-mentioned cross section photograph and is parallel with the length direction (L-axis direction). Or, the length of the body 110 may refer to the arithmetic average of the lengths of at least two line segments of a plurality of line segments, each of which connects two outermost boundary lines of the body 110 facing each other in the length direction (L-axis direction), shown in the above-mentioned cross section photograph and is parallel with the length direction (L-axis direction).

In an optical microscope photograph or scanning electron microscope (SEM) photograph of the lengthwise (L-axis direction) and thickness-wise (T-axis direction) cross section of the body 110 at the center in the width direction (W-axis direction), the thickness of the body 110 may refer to the maximum of the lengths of a plurality of line segments, each of which connects two outermost boundary lines of the body 110 facing each other in the thickness direction (T-axis direction), shown in the above-mentioned cross section photograph, and is parallel with the thickness direction (T-axis direction). Alternatively, the thickness of the body 110 may refer to the minimum of the lengths of a plurality of line segments, each of which connects two outermost boundary lines of the body 110 facing each other in the thickness direction (T-axis direction), shown in the above-mentioned cross section photograph and is parallel with the thickness direction (T-axis direction). Or, the thickness of the body 110 may refer to the arithmetic average of the lengths of at least two line segments of a plurality of line segments, each of which connects two outermost boundary lines of the body 110 facing each other in the thickness direction (T-axis direction), shown in the above-mentioned cross section photograph and is parallel with the thickness direction (T-axis direction).

In an optical microscope photograph or scanning electron microscope (SEM) photograph of the lengthwise (L-axis direction) and width-wise (W-axis direction) cross section of the body 110 at the center in the thickness direction (T-axis direction), the width of the body 110 may refer to the maximum of the lengths of a plurality of line segments, each of which connects two outermost boundary lines of the body 110 facing each other in the width direction (W-axis direction), shown in the above-mentioned cross section photograph, and is parallel with the width direction (W-axis direction). Alternatively, the width of the body 110 may refer to the minimum of the lengths of a plurality of line segments, each of which connects two outermost boundary lines of the body 110 facing each other in the width direction (W-axis direction), shown in the above-mentioned cross section photograph and is parallel with the width direction (W-axis direction). Or, the width of the body 110 may refer to the arithmetic average of the lengths of at least two line segments of a plurality of line segments, each of which connects two outermost boundary lines of the body 110 facing each other in the width direction (W-axis direction), shown in the above-mentioned cross section photograph and is parallel with the width direction (W-axis direction).

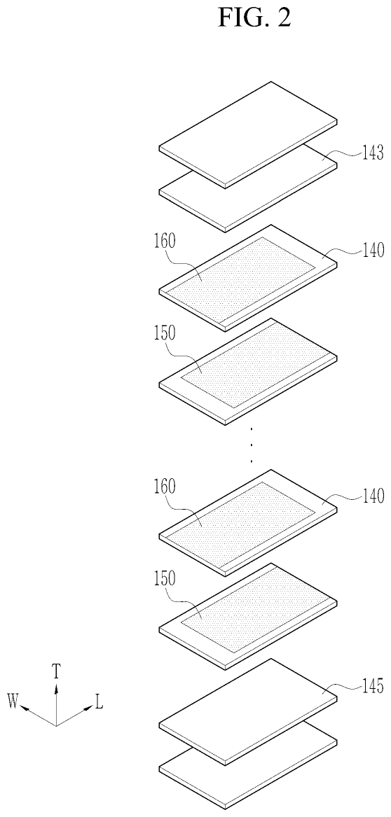

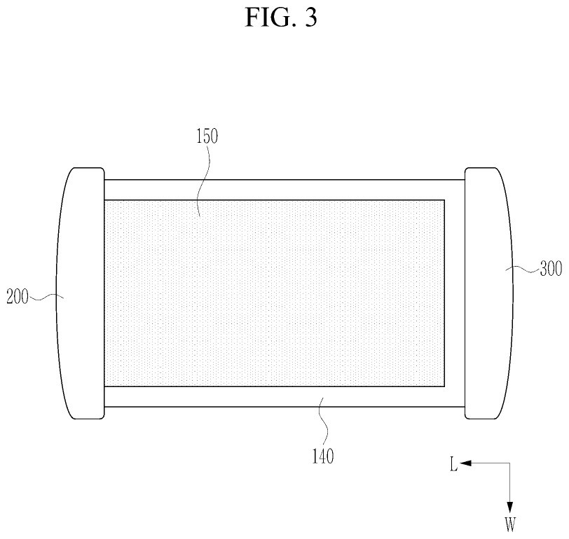

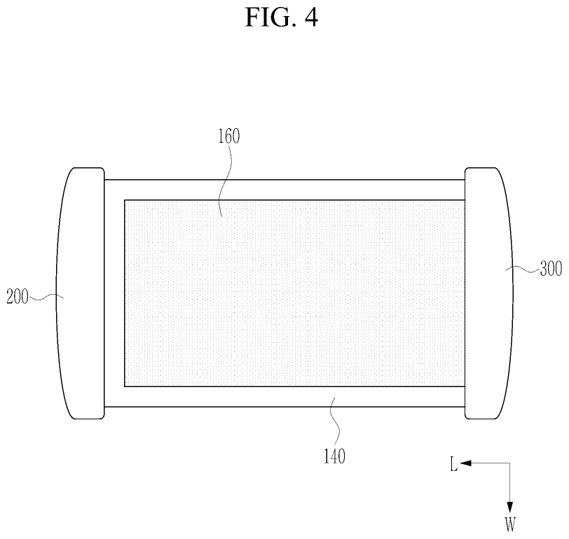

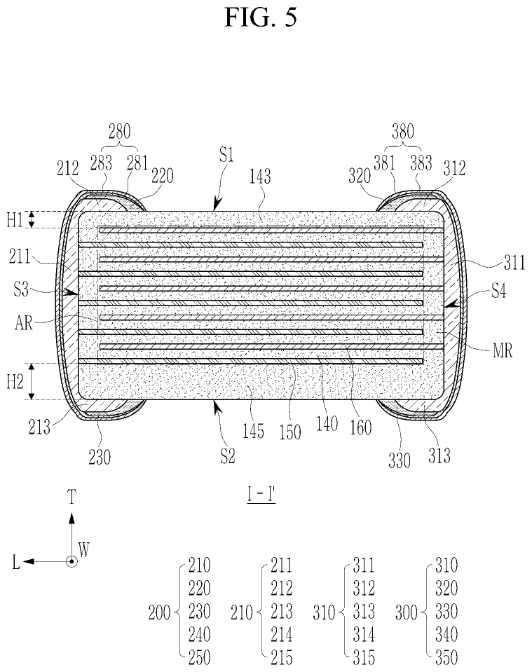

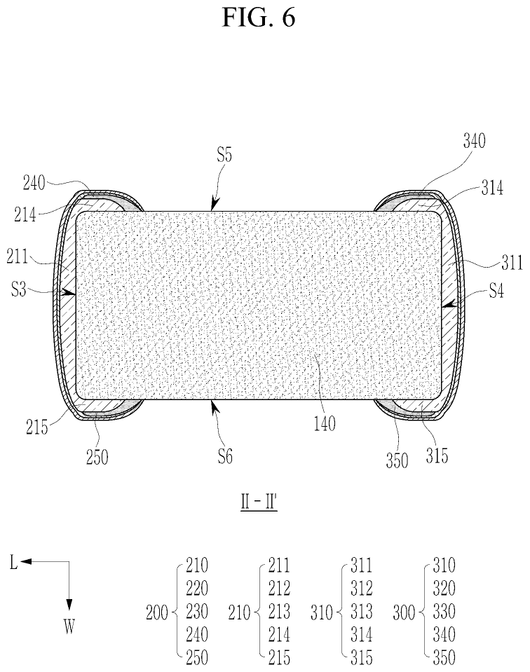

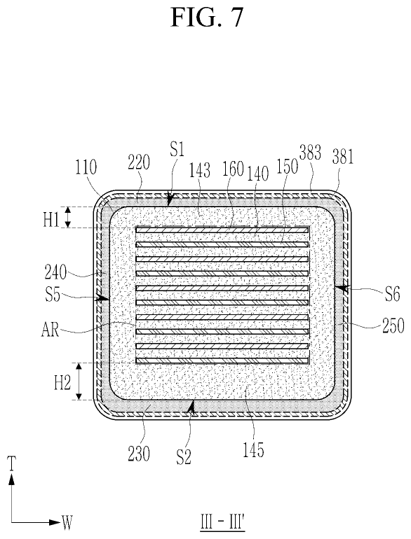

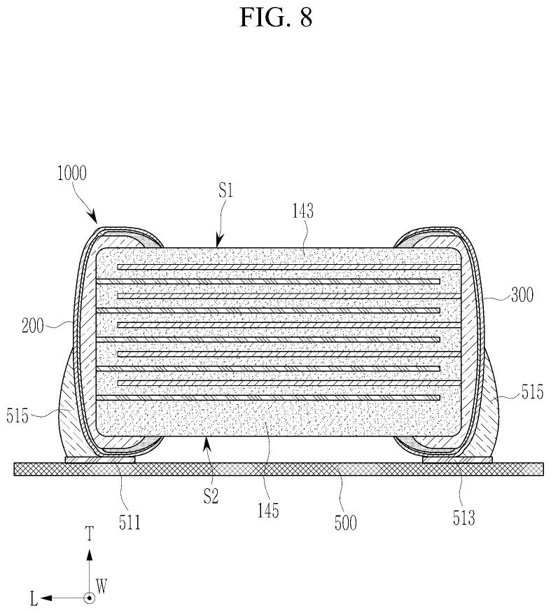

FIG. 2 illustrates a perspective view showing a stacked structure of an internal electrode in the multilayer ceramic capacitor of FIG. 1, FIG. 3 illustrates a top plan view schematically showing a first internal electrode of the multilayer ceramic capacitor of FIG. 1, and FIG. 4 illustrates a plan view schematically showing a second internal electrode of the multilayer ceramic capacitor of FIG. 1. FIG. 5 illustrates a cross-sectional view taken along a line I-I′ of FIG. 1, FIG. 6 illustrates a cross-sectional view taken along a line II-II′ of FIG. 1, and FIG. 7 illustrates a cross-sectional view taken along a line III-III′ of FIG. 1. FIG. 8 illustrates a cross-sectional view schematically showing the multilayer ceramic capacitor of FIG. 1 mounted on a circuit board.

Referring to FIG. 2, FIG. 3, FIG. 4, FIG. 5, FIG. 6, FIG. 7, and FIG. 8, the body 110 may include a plurality of dielectric layers 140, a first cover layer 143, a second cover layer 145, a first internal electrode 150, and a second internal electrode 160.

The dielectric layers 140 are stacked in the thickness direction (T-axis direction) of the body 110. The boundaries between the dielectric layers 140 may be invisible to human eyes. For example, the boundaries between the dielectric layers 140 may be difficult to see without the use of a scanning electron microscope (SEM), and the plurality of dielectric layers 140 may look like an integrated structure.

The dielectric layers 140 may contain a ceramic material. For example, the ceramic material may contain dielectric ceramic such as BaTiO₃, CaTiO₃, SrTiO₃, or CaZrO₃. Also, the dielectric layers may further contain an auxiliary component such as a manganese (Mn) compound, an iron (Fe) compound, a chromium (Cr) compound, a cobalt (Co) compound, and a nickel (Ni) compound, etc., in addition to the ceramic material. For example, the dielectric layers may comprise (Ba₁₋ₓCaₓ)TiO₃ (wherein 0<x<1), Ba(Ti_{1-y}Ca_{y})O₃ (wherein 0<y<1), (Ba₁₋ₓCaₓ)(Ti_{1-y}Zr_{y})O₃ (wherein 0<x<1 and 0<y<1), Ba(Ti_{1-y}Zr_{y})O₃ (wherein 0<y<1), or the like, i.e., BaTiO₃ doped with calcium (Ca), zirconium (Zr), etc., but the disclosure is not limited thereto.

Further, the dielectric layers 140 may further contain one or more of ceramic additives, organic solvents, plasticizers, binders, and dispersing agents. Examples of the ceramic additives may include transition metal oxides or carbides, rare earth elements, magnesium (Mg), aluminum (Al), etc.

The first internal electrode 150 and the second internal electrode 160 may be alternately stacked with the dielectric layer 140 interposed therebetween. This stack structure may be repeated inside the body 110, and the internal electrode closest to the first surface S1 of the body 110 may be a first internal electrode 150 or may be a second internal electrode 160, and the internal electrode closest to the second surface S2 of the body 110 may be a first internal electrode 150 or may be a second internal electrode 160.

The first internal electrodes 150 and the second internal electrodes 160 may have different polarities, and may be electrically insulated from each other by the dielectric layers 140 disposed therebetween.

The first internal electrode 150 and the second internal electrode 160 may be disposed staggered from each other in the length direction (L-axis direction) with the dielectric layer 140 interposed therebetween. One end of the first internal electrode 150 may be exposed from the third surface S3 of the body 110, and one end of the second internal electrode 160 may be exposed from the fourth surface S4 of the body 110. The end of the first internal electrode 150 exposed from the third surface S3 of the body 110 may be connected to the first external electrode 200. The end of the second internal electrode 160 exposed from the fourth surface S4 of the body 110 may be connected to the second external electrode 300.

The first internal electrodes 150 and the second internal electrodes 160 may be formed on the surface of the dielectric layers 140 by printing a conductive paste including a metal. For example, the internal electrodes may be formed on the surfaces of the dielectric layers by screen printing or gravure printing using conductive paste containing nickel (Ni) or a nickel (Ni) alloy. However, the present embodiment is not limited thereto.

When a voltage is applied to the first external electrode 200 and the second external electrode 300, charge accumulates between the first internal electrode 150 and the second internal electrode 160. That is, capacitance may be obtained between the first internal electrode 150 electrically connected to the first external electrode 200 and the second internal electrode 160 electrically connected to the second external electrode 300. The capacitance of the multilayer ceramic capacitor 1000 is proportional to the overlapping area of the first internal electrode 150 and the second internal electrode 160 overlapping each other when viewed in the thickness direction (T-axis direction) (e.g., overlapping each other in the length direction, the width direction, or both of the length and width directions).

In other words, the multilayer ceramic capacitor 1000 may include an active region AR and a margin region MR.

The active region (AR) may refer to a region where the first internal electrode 150 and the second internal electrode 160 overlap when viewed along the thickness direction (T-axis direction).

The margin region MR may refer to a region that includes a dielectric layer 140 identical to the dielectric layer 140 in the remaining region of the body 110, but in which no internal electrodes 150 and 160 are disposed.

Referring to FIGS. 5 and 7, a first cover layer 143 and a second cover layer 145 may be disposed on the outermost side of the active region AR in the thickness direction (T-axis direction).

The first cover layer 143 may be disposed between the first surface S1 of the body 110 and the internal electrode closest thereto. The second cover layer 145 may be disposed between the second surface S2 of the body 110 and the internal electrode closest thereto.

In other words, inside the body 110, the first cover layer 143 may be disposed on the uppermost internal electrode, and the second cover layer 145 may be disposed below the lowermost internal electrode. The first cover layer 143 and the second cover layer 145 may have the same composition as that of the dielectric layers 140. The first cover layer 143 and the second cover layer 145 may be formed by stacking one or more dielectric layers on the outer surface of the uppermost internal electrode and the outer surface of the lowermost internal electrode, respectively. Meanwhile, the first cover layer 143 and the second cover layer 145 may have a composition different from that of the dielectric layer 140.

The first cover layer 143 and the second cover layer 145 may serve to prevent damage to the first internal electrode 150 and the second internal electrode 160 by physical or chemical stress.

An average thickness H2 of the second cover layer 145 may be greater than an average thickness H1 of the first cover layer 143.

Herein, the average thickness H1 of the first cover layer 143 and the average thickness H2 of the second cover layer 145 may be measured based on an optical microscope or scanning electron microscope (SEM) photograph of a cross-section taken along the length direction (L-axis direction)-thickness direction (T-axis direction) at a center of the multilayer ceramic capacitor 1000 in the width direction (W-axis direction). The average thickness H1 of the first cover layer 143 may be an arithmetic mean of the distances measured from thirty (30) equally spaced points in the length direction (L-axis direction) on the internal electrode closest to the first surface S1 of the body 110 among the internal electrodes shown in the above described cross-sectional photograph to the first surface S1. The above described thirty (30) points may be selected within the active region. The average thickness H2 of the second cover layer 145 may be an arithmetic mean of the distances measured from thirty (30) equally spaced points in the length direction (L-axis direction) on the internal electrode closest to the second surface S2 of the body 110 among the internal electrodes shown in the above described cross-sectional photograph to the second surface S2. The above described thirty (30) points may be selected within the active region.

For example, the second cover layer 145 may be made thicker by increasing the number of dielectric layers included in the second cover layer 145 compared to the number of dielectric layers included in the first cover layer 143.

Referring to FIG. 8, the multilayer ceramic capacitor 1000 may be mounted on a circuit board 500. A first electrode pad 511 and a second electrode pad 513 may be disposed on the circuit board 500. The first electrode pad 511 may be electrically connected to the first external electrode 200 by a conductive bonding member 515, and the second electrode pad 513 may be electrically connected to the second external electrode 300 by another conductive bonding member 515. For example, a conductive bonding member 515 may include a solder.

Herein, when current is applied to the multilayer ceramic capacitor 1000, the body 110 may expand in the length direction (L-axis direction) due to the piezoelectric effect, and since the second cover layer 145 is thicker than the first cover layer 143, a reverse phase may occur in the second cover layer 143, resulting in a displacement offset effect. Accordingly, vibration transferred to the circuit board 500 may be reduced, and acoustic noise may be reduced.

The first external electrode 200 and the second external electrode 300 are disposed outside the body 110.

The first external electrode 200 may be disposed on the third surface S3 of body 110, and may extend onto the first surface S1, the second surface S2, the fifth surface S5, and the sixth surface S6. The second external electrode 300 may be disposed on the fourth surface S4 of body 110, and may extend onto the first surface S1, the second surface S2, the fifth surface S5, and the sixth surface S6.

The first external electrode 200 may include a first electrode layer 210, a first conductive resin layer 220, a second conductive resin layer 230, a third conductive resin layer 240, and a fourth conductive resin layer 250.

The first electrode layer 210 may include a metal. For example, the first electrode layer 210 may include one or more of silver (Ag), lead (Pb), platinum (Pt), nickel (Ni), copper (Cu), and an alloy thereof.

The first electrode layer 210 may include a first connection portion 211, a first band portion 212, a second band portion 213, a third band portion 214, and a fourth band portion 215.

The first connection portion 211 may be a portion that covers the third surface S3 of the body 110, and is in contact with the exposed ends of the first internal electrodes 150 to be electrically connected to them.

The first band portion 212 may extend from the first connection portion 211 to cover a portion of the first surface S1 of the body 110, and the second band portion 213 may extend from the first connection portion 211 to cover a portion of the second surface S2 of the body 110.

The third band portion 214 may extend from the first connection portion 211 to cover a portion of the fifth surface S5 of the body 110, and the fourth band portion 215 may extend from the first connection portion 211 to cover a portion of the sixth surface S6 of the body 110.

The first conductive resin layer 220 may cover the first band portion 212, and may expose the first connection portion 211. That is, the first conductive resin layer 220 may not be disposed on the first connection portion 211, or may be partially disposed on the first connection portion 211. For example, the first conductive resin layer 220 may extend from the first band portion 212 onto the first connection portion 211 to cover a portion of the first connection portion 211.

The first conductive resin layer 220 may cover a portion or all of the first band portion 212. In addition, the first conductive resin layer 220 may cover a portion of the first surface S1 of the body 110.

The second conductive resin layer 230 may cover the second band portion 213, and may expose the first connection portion 211. That is, the second conductive resin layer 230 may not be disposed on the first connection portion 211, or may be partially disposed on the first connection portion 211. For example, the second conductive resin layer 230 may extend from the second band portion 213 onto the first connection portion 211 to cover a portion of the first connection portion 211.

The second conductive resin layer 230 may cover a portion or all of the second band portion 213. In addition, the second conductive resin layer 230 may cover a portion of the second surface S2 of the body 110.

The third conductive resin layer 240 may cover the third band portion 214, and may expose the first connection portion 211. That is, the third conductive resin layer 240 may not be disposed on the first connection portion 211, or may be partially disposed on the first connection portion 211. For example, the third conductive resin layer 240 may extend from the third band portion 214 onto the first connection portion 211 to cover a portion of the first connection portion 211.

The third conductive resin layer 240 may cover a portion or all of the third band portion 214. In addition, the third conductive resin layer 240 may cover a portion of the fifth surface S5 of the body 110.

The fourth conductive resin layer 250 may cover the fourth band portion 215, and may expose the first connection portion 211. That is, the fourth conductive resin layer 250 may not be disposed on the first connection portion 211, or may be partially disposed on the first connection portion 211. For example, the fourth conductive resin layer 250 may extend from the fourth band portion 215 onto the first connection portion 211 to cover a portion of the first connection portion 211.

The fourth conductive resin layer 250 may cover a portion or all of the fourth band portion 215. In addition, the fourth conductive resin layer 250 may cover a portion of the sixth surface S6 of the body 110.

The first conductive resin layer 220 may include a metal and a resin.

The metal included in the first conductive resin layer 220 may include, e.g., copper (Cu), silver (Ag), nickel (Ni), tin (Sn) or an alloy thereof.

The resin included in the first conductive resin layer 220 may be, e.g., various known thermosetting resins such as an epoxy resin, a phenol resin, a urethane resin, a silicone resin, and a polyimide resin.

The second conductive resin layer 230, the third conductive resin layer 240, and the fourth conductive resin layer 250 include components that are identical or similar to those of the first conductive resin layer 220 described above, and accordingly, a repeated description thereof will be omitted.

After the first electrode layer 210 is formed, a conductive resin composition comprising a metal powder and a thermosetting resin may be a bisphenol A resin, glycol epoxy resin, Novolac epoxy resin, or a resin which has a low molecular weight and is liquid at room temperature among derivatives thereof, but is not limited thereto. For example, the conductive resin composition may be prepared by mixing a silver (Ag) powder, a copper (Cu) powder, a silver (Ag)-coated copper (Cu) powder, a tin (Sn)-based solder powder, and thermosetting resin, and then dispersing the mixture using a 3-roll mill. The tin (Sn)-based solder powder may include at least one of tin (Sn), Sn_{96.5}Ag_{3.0}Cu_{0.5}, Sn₄₂Bi₇₈, and Sn₇₂Bi₂₈, but the disclosure is not limited thereto. Thereafter, the conductive resin composition on the first connection portion 211, and then, a curing heat treatment may be performed to form the first conductive resin layer 220 on the first band portion 212, the second conductive resin layer 230 on the second band portion 213, the third conductive resin layer 240 on the third band portion 214, and the fourth conductive resin layer 250 on the fourth band portion 215. Accordingly, the first connection portion 211 may be disposed on the third surface S3 of the body 110, the first band portion 212, the second band portion 213, the third band portion 214, and the fourth band portion 215 may be disposed on the first surface S1, the second surface S2, the fifth surface S5, and the sixth surface S6, and the first conductive resin layer 220, the second conductive resin layer 230, the third conductive resin layer 240, and the fourth conductive resin layer 250 may be disposed, respectively.

Unlike in the present embodiment, if both the electrode layer and the resin layer covering the electrode layer are disposed on the third surface S3 of the body 110, the resin layer has lower electrical connectivity than the electrode layer, so equivalent series resistance (ESR) of the first external electrode may increase. There is also a risk of lifting due to out-gassing from the resin layer during a high-temperature reflow process. Furthermore, the resin layer is present on the electrode layer, the external electrode may be thick and a relative volume of the body may be small compared to a case in which only the electrode layer is present, resulting in that effective capacity of the multilayer ceramic capacitor is reduced.

On the other hand, according to the present embodiment, the first connection portion 211 is disposed on the third surface S3 of the body 110, and the first conductive resin layer 220, the second conductive resin layer 230, the third conductive resin layer 240, and the fourth conductive resin layer 250 are not disposed on the third surface S3 or are only partially disposed, and thus, the above-described problem may not occur.

Meanwhile, the first external electrode 200 may further include a first plating layer 280.

The first plating layer 280 may be connected to the first connection portion 211, and may cover the first conductive resin layer 220, the second conductive resin layer 230, the third conductive resin layer 240, and the fourth conductive resin layer 250. The first plating layer 280 may include a first layer 281 and a second layer 283. The first layer 281 may be disposed on the first connection portion 211, the first conductive resin layer 220, the second conductive resin layer 230, the third conductive resin layer 240, and the fourth conductive resin layer 250, and the second layer 283 may be disposed on the first layer 281. The first layer 281 may include nickel (Ni) and the second layer 283 may include tin (Sn), but the present embodiment is not limited thereto.

Meanwhile, when the first conductive resin layer 220 covers a portion of the first band portion 212, the remaining portion of the first band portion 212, i.e., the portion that is not covered by the first conductive resin layer 220, may be covered by the first plating layer 280. This may be equally applied to the second band portion 213, the third band portion 214, and the fourth band portion 215.

The second external electrode 300 include a second electrode layer 310, a fifth conductive resin layer 320, a sixth conductive resin layer 330, a seventh conductive resin layer 340, and an eighth conductive resin layer 350.

The second electrode layer 310 may include a metal. For example, the second electrode layer 310 may include one or more of silver (Ag), lead (Pb), platinum (Pt), nickel (Ni), copper (Cu), and an alloy thereof.

The second electrode layer 310 may include a second connection portion 311, a fifth band portion 312, a sixth band portion 313, a seventh band portion 314, and an eighth band portion 315.

The second connection portion 311 may be a portion that covers the fourth surface S4 of the body 110, and is in contact with the exposed ends of the second internal electrodes 160 to be electrically connected to them.

The fifth band portion 312 may extend from the second connection portion 311 to cover a portion of the first surface S1 of the body 110, and the sixth band portion 313 may extend from the second connection portion 311 to cover a portion of the second surface S2 of the body 110.

The seventh band portion 314 may extend from the second connection portion 311 to cover a portion of the fifth surface S5 of the body 110, and the eighth band portion 315 may extend from the second connection portion 311 to cover a portion of the sixth surface S6 of the body 110.

The fifth conductive resin layer 320 may cover the fifth band portion 312, and may expose the second connection portion 311. That is, the fifth conductive resin layer 320 may not be disposed on the second connection portion 311, or may be partially disposed on the second connection portion 311. For example, the fifth conductive resin layer 320 may extend from the fifth band portion 312 onto the second connection portion 311 to cover a portion of the second connection portion 311.

The fifth conductive resin layer 320 may cover a portion or all of the fifth band portion 312. In addition, the fifth conductive resin layer 320 may cover a portion of the first surface S1 of the body 110.

The sixth conductive resin layer 330 may cover the sixth band portion 313, and may expose the second connection portion 311. That is, the sixth conductive resin layer 330 may not be disposed on the second connection portion 311, or may be partially disposed on the second connection portion 311. For example, the sixth conductive resin layer 330 may extend from the sixth band portion 313 onto the second connection portion 311 to cover a portion of the second connection portion 311.

The sixth conductive resin layer 330 may cover a portion or all of the sixth band portion 313. In addition, the sixth conductive resin layer 330 may cover a portion of the second surface S2 of the body 110.

The fifth conductive resin layer 320 may include a metal and a resin.

The metal included in the fifth conductive resin layer 320 may include, e.g., copper (Cu), silver (Ag), nickel (Ni), tin (Sn) or an alloy thereof.

The resin included in the fifth conductive resin layer 320 may be, e.g., various known thermosetting resins such as an epoxy resin, a phenol resin, a urethane resin, a silicone resin, and a polyimide resin.

The sixth conductive resin layer 330, the seventh conductive resin layer 340, and the eighth conductive resin layer 350 include components that are identical or similar to those of the fifth conductive resin layer 320 described above, and accordingly, a repeated description thereof will be omitted.

The second external electrode 300 may further include a second plating layer 380.

The second plating layer 380 may be connected to the second connection portion 311, and may cover the fifth conductive resin layer 320, the sixth conductive resin layer 330, the seventh conductive resin layer 340, and the eighth conductive resin layer 350. The second plating layer 380 may include a third layer 381 and a fourth layer 383. The third layer 381 may be disposed on the second connection portion 311, the fifth conductive resin layer 320, the sixth conductive resin layer 330, the seventh conductive resin layer 340, and the eighth conductive resin layer 350, and the fourth layer 383 may be disposed on the third layer 381. The third layer 381 may include nickel (Ni) and the fourth layer 383 may include tin (Sn), but the present embodiment is not limited thereto.

Meanwhile, when the fifth conductive resin layer 320 covers a portion of the fifth band portion 312, the remaining portion of the fifth band portion 312, i.e., the portion that is not covered by the fifth conductive resin layer 320, may be covered by the second plating layer 380. This may be equally applied to the sixth band portion 313, the seventh band portion 314, and the eighth band portion 315.

The second external electrode 300 may correspond to the first external electrode 200 except for the location thereof, so a repeated description thereof will be omitted.

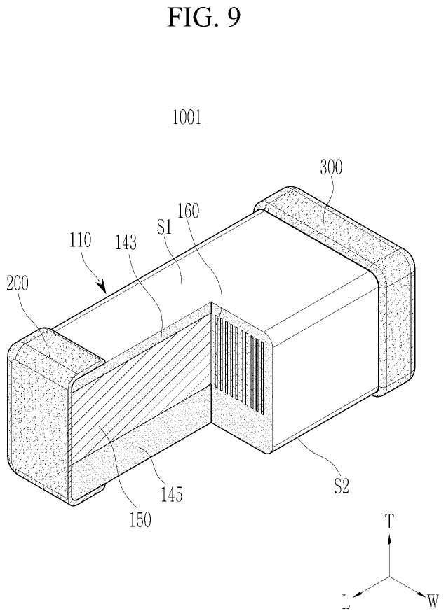

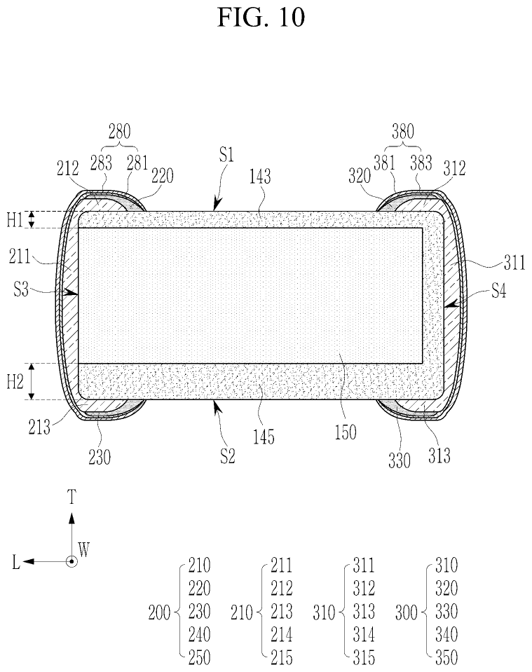

FIG. 9 illustrates a perspective view schematically showing a modified example of FIG. 1, and FIG. 10 illustrates a schematic cross-sectional view of FIG. 9.

Referring to FIG. 9 and FIG. 10, the multilayer ceramic capacitor 1001 may include a body 110, a first external electrode 200, and a second external electrode 300. The body 110 may include a plurality of dielectric layers 140, a first cover layer 143, a second cover layer 145, a first internal electrode 150, and a second internal electrode 160.

An average thickness H2 of the second cover layer 145 may be greater than an average thickness H1 of the first cover layer 143.

The first internal electrodes 150 and the second internal electrodes 160 may be stacked in the width direction (W-axis direction).

The remaining components are identical to the components of the multilayer ceramic capacitor shown in FIG. 1, so a repeated description thereof will be omitted.

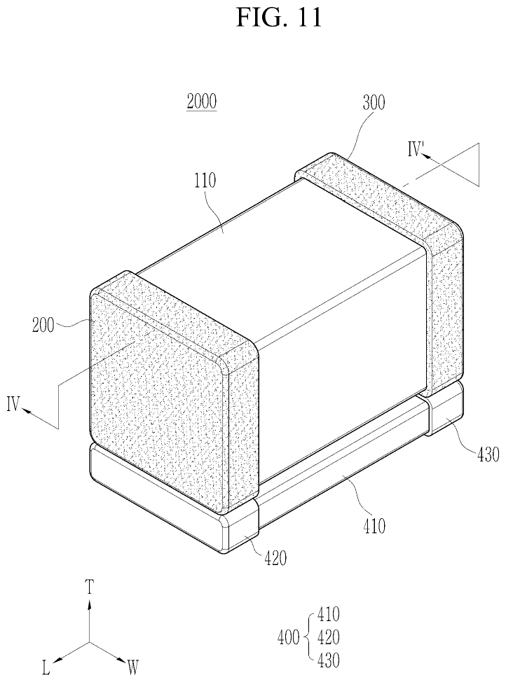

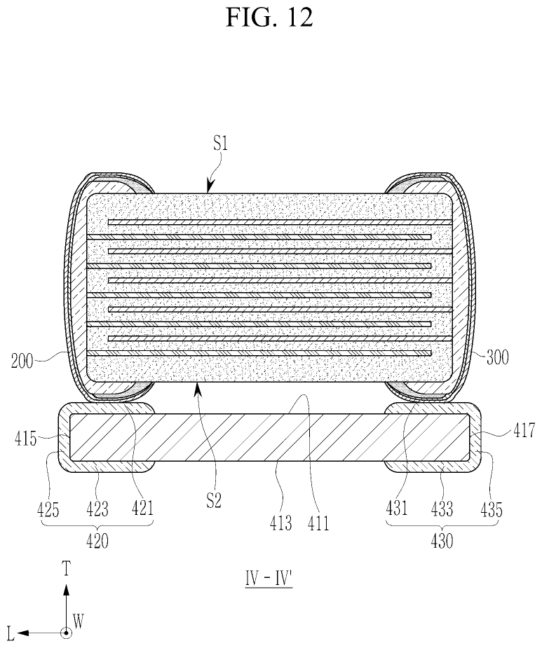

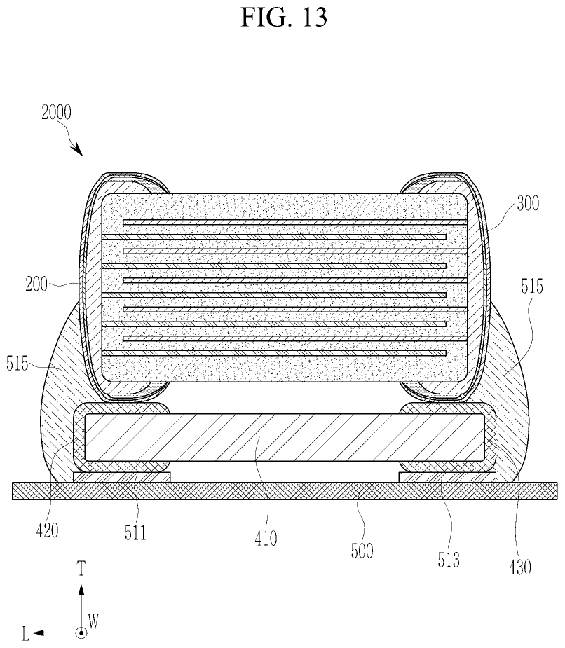

FIG. 11 illustrates a schematic perspective view showing a multilayer ceramic capacitor according to another embodiment, FIG. 12 illustrates a cross-sectional view taken along line IV-IV′ of FIG. 11, and FIG. 13 illustrates a cross-sectional view schematically showing the multilayer ceramic capacitor of FIG. 11 mounted on a circuit board.

Referring to FIGS. 11, 12, and 13, the multilayer ceramic capacitor 2000 may include a body 110, a first external electrode 200, a second external electrode 300, and an interposer 400.

The interposer 400 may include an interposer body 410, a first connection electrode 420, and a second connection electrode 430.

The interposer body 410 may be made of an insulating material.

For example, the insulating material may be an elastic insulating resin or a glass epoxy resin. The insulating resin and the glass epoxy resin are elastic, so they may reduce acoustic noise by absorbing the vibrations of the multilayer ceramic capacitor.

As another example, the insulating material may be alumina (Al₂O₃). Alumina has no piezoelectric properties, so it may suppress the transmission of vibration itself generated in the multilayer ceramic capacitor, ultimately reducing acoustic noise.

The interposer body 410 may have a plate shape, for example. The interposer body 410 may include a first main surface 411, a second main surface 413, a first end surface 415, and a second end surface 417.

The first main surface 411 may face the second surface S2 of the body 110, and the second main surface 413 may be disposed opposite the first main surface 411 in the thickness direction (T-axis direction).

The first end surface 415 may connect the first main surface 411 and the second main surface 413. The second end surface 417 may be disposed opposite the first end surface 415 in the length direction (L-axis direction), and may connect the first main surface 411 and the second main surface 413.

The first connection electrode 420 may include a first joint portion 421, a first mounting portion 423, and a first interconnecting portion 425.

The first connection electrode 420 may include copper (Cu), nickel (Ni), or tin (Sn), but the present embodiment is not limited thereto.

The first joint portion 421 may be disposed on the first main surface 411 of the interposer body 410, and may be electrically connected to the first external electrode 200.

The first mounting portion 423 may be disposed on the second main surface 413 of the interposer body 410. The first mounting portion 423 may be connected to the first electrode pad 511 of the circuit board 500.

The first interconnecting portion 425 may be disposed on the first end surface 415 of the interposer body 410, and may connect the first joint portion 421 and the first mounting portion 423.

The second connection electrode 430 may include a second joint portion 431, a second mounting portion 433, and a second interconnecting portion 435.

The second joint portion 431 may be disposed on the first main surface 411 of the interposer body 410, and may be electrically connected to the second external electrode 300.

The second mounting portion 433 may be disposed on the second main surface 413 of the interposer body 410. The second mounting portion 433 may be connected to the second electrode pad 513 of the circuit board 500.

The second interconnecting portion 435 may be disposed on the second end surface 417 of the interposer body 410, and may connect the second joint portion 431 and the second mounting portion 433.

Referring to FIG. 13, the multilayer ceramic capacitor 2000 may be mounted on a circuit board 500. A first electrode pad 511 and a second electrode pad 513 may be disposed on the circuit board 500. The first electrode pad 511 may be electrically connected to the first connection electrode 420 and the first external electrode 200 by a conductive bonding member 515, and the second electrode pad 513 may be electrically connected to the second connection electrode 430 and the second external electrode 300 by another conductive bonding member 515. The conductive bonding member 515 may include, e.g., a solder.

Here, the multilayer ceramic capacitor 2000 may include the interposer 400, so the vibration transmitted to the circuit board 500 may be reduced. Accordingly, acoustic noise may be reduced.

The remaining components are identical to the components of the multilayer ceramic capacitor shown in FIG. 1, so a repeated description thereof will be omitted.

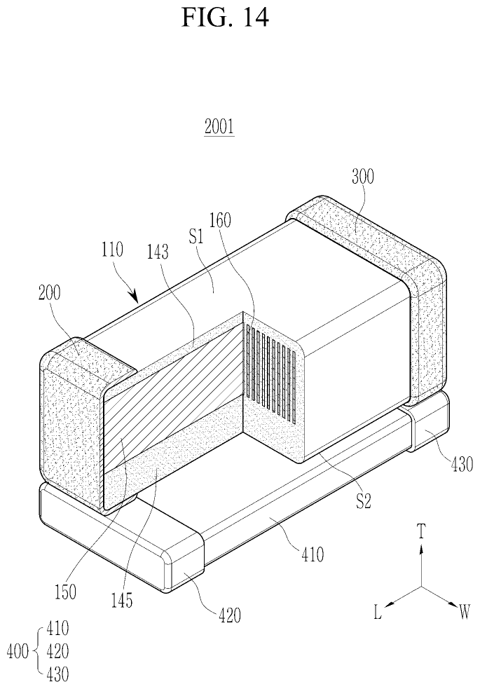

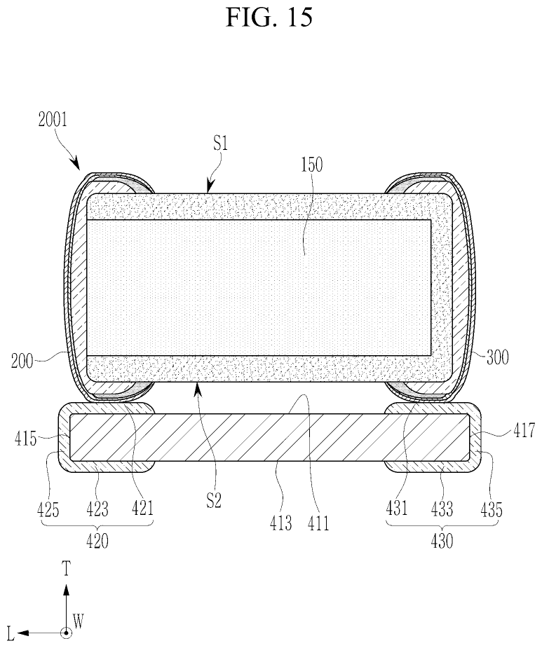

FIG. 14 illustrates a perspective view schematically showing a modified example of FIG. 13, and FIG. 15 illustrates a schematic cross-sectional view of FIG. 14.

Referring to FIG. 14 and FIG. 15, the multilayer ceramic capacitor 2001 may include a body 110, a first external electrode 200, a second external electrode 300, and an interposer 400.

The body 110 may include a plurality of dielectric layers 140, a first cover layer 143, a second cover layer 145, a first internal electrode 150, and a second internal electrode 160.

The first internal electrodes 150 and the second internal electrodes 160 may be stacked in the width direction (W-axis direction).

The remaining components are identical to the components of the multilayer ceramic capacitor shown in FIG. 13, so a repeated description thereof will be omitted.

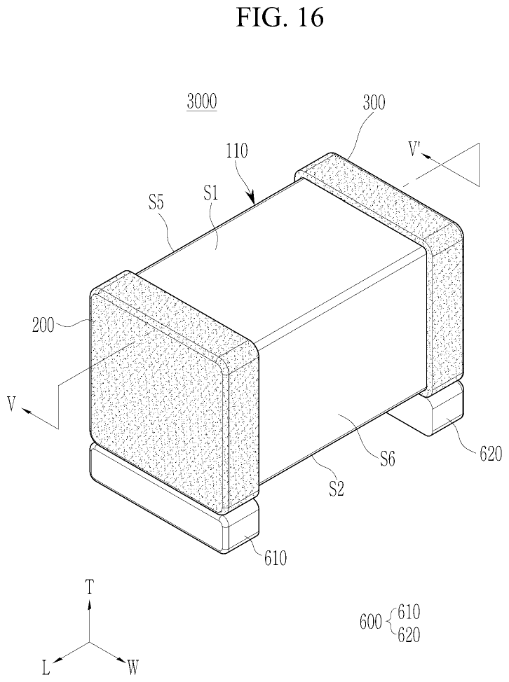

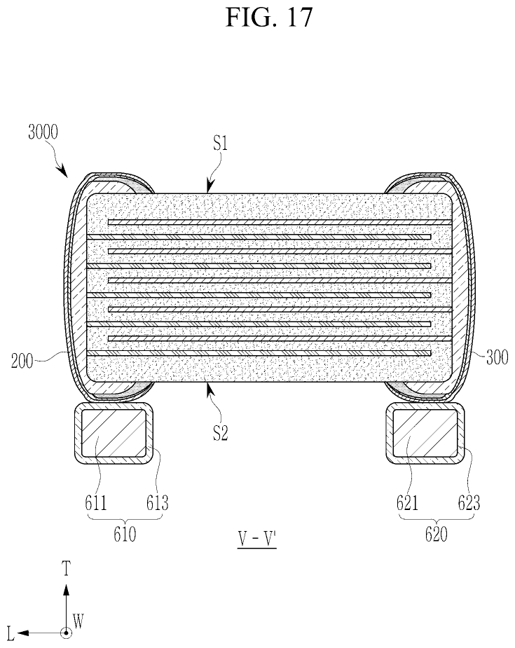

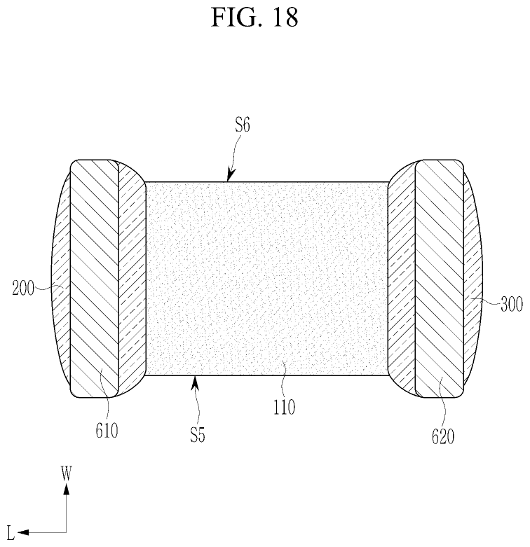

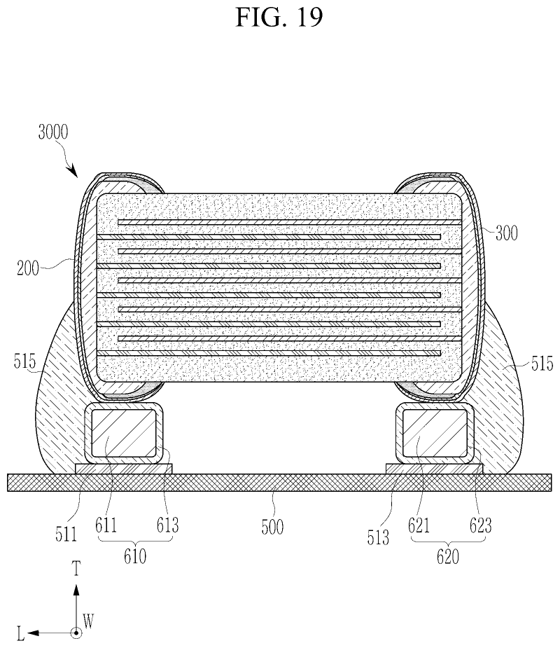

FIG. 16 illustrates a schematic perspective view showing a multilayer ceramic capacitor according to another embodiment, FIG. 17 illustrates a cross-sectional view taken along line V-V′ of FIG. 16, FIG. 18 illustrates a bottom view of FIG. 16, and FIG. 19 illustrates a cross-sectional view schematically showing the multilayer ceramic capacitor of FIG. 16 mounted on a circuit board.

Referring to FIGS. 16, 17, 18, and 19, the multilayer ceramic capacitor 3000 may include a body 110, a first external electrode 200, a second external electrode 300, and a bump electrode 600.

The bump electrode 600 may include a first bump electrode 610 and a second bump electrode 620.

The first bump electrode 610 may be electrically connected to the first external electrode 200 on the second surface S2 of the body 110.

The first bump electrode 610 may include a first bump body 611 and a first conductive layer 613. For example, the first bump electrode 610 may have a roughly rectangular hexahedral shape.

The first bump body 611 may include a metal or an insulating material.

For example, the metal included in the first bump body 611 may be copper (Cu), and the insulating material may be alumina (Al₂O₃). However, the present embodiment is not limited thereto.

The first conductive layer 613 may be disposed on the surface of the first bump body 611, and may be connected to the first external electrode 200. For example, a metal may be plated on the surface of the first bump body 611 to form the first conductive layer 613. For example, the first conductive layer 613 may include nickel (Ni), tin (Sn), or gold (Au).

The second bump electrode 620 may be electrically connected to the second external electrode 300 on the second surface S2 of the body 110. The second bump electrode 620 may be spaced apart from the first bump electrode 610 in the length direction (L-axis direction).

The second bump electrode 620 may include a second bump body 621 and a second conductive layer 623. For example, the second bump electrode 620 may have a roughly rectangular hexahedral shape.

The second bump body 621 may include a metal or an insulating material.

For example, the metal included in the second bump body 621 may be copper (Cu), and the insulating material may be alumina (Al₂O₃). However, the present embodiment is not limited thereto.

The second conductive layer 623 may be disposed on the surface of the second bump body 621, and may be connected to the second external electrode 300. For example, a metal may be plated on the surface of the second bump body 621 to form the second conductive layer 623. For example, the second conductive layer 623 may include nickel (Ni), tin (Sn), or gold (Au).

Since the multilayer ceramic capacitor 3000 includes the first bump electrode 610 and the second bump electrode 620, when the multilayer ceramic capacitor 3000 is mounted on the circuit board 500, the distance between the circuit board 500 and the multilayer ceramic capacitor 3000 may be increased. Accordingly, the vibration transmitted to the circuit board 500 may be reduced, and acoustic noise may be reduced.

The remaining components are identical to the components of the multilayer ceramic capacitor shown in FIG. 1, so a repeated description thereof will be omitted.

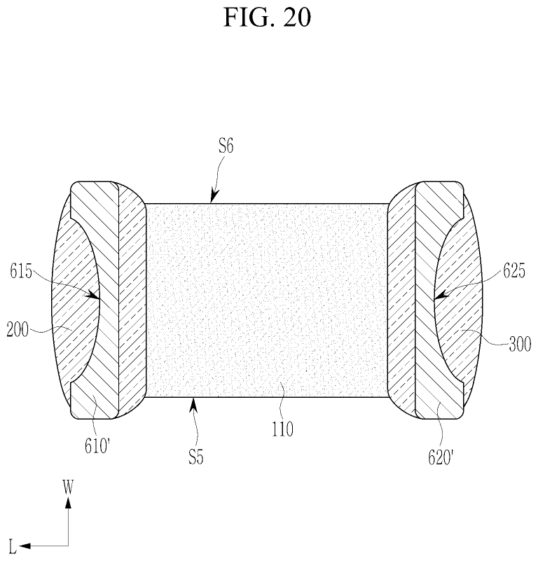

FIG. 20 illustrates a bottom view schematically showing a modified example of FIG. 16.

Referring to FIG. 20, a first bump electrode 610′ may include a first concave portion 615, and a second bump electrode 620′ may include a second concave portion 625.

The first concave portion 615 may have a shape in which a portion of a side surface of the first bump electrode 610′ in the length direction (L-axis direction) is sunken, and the second concave portion 625 may have a shape in which a portion of a side surface of the second bump electrode 620′ in the length direction (L-axis direction) is sunken.

Specific shapes of the first concave portion 615 and the second concave portion 625 may be modified in various ways to improve mountability or reduce acoustic noise.

The remaining components are identical to the components of the multilayer ceramic capacitor shown in FIG. 16, so a repeated description thereof will be omitted.

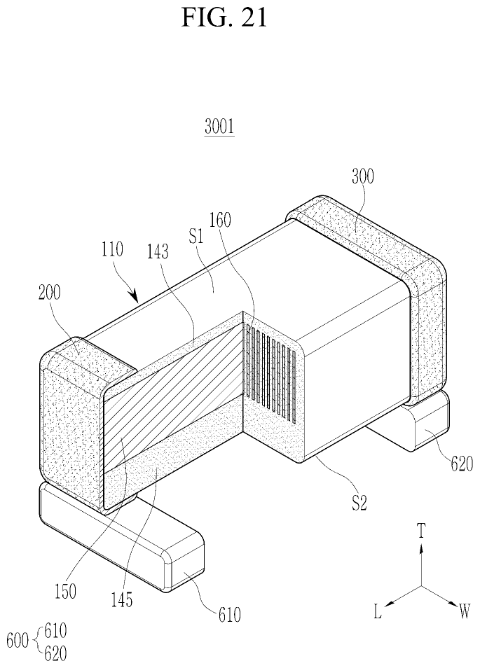

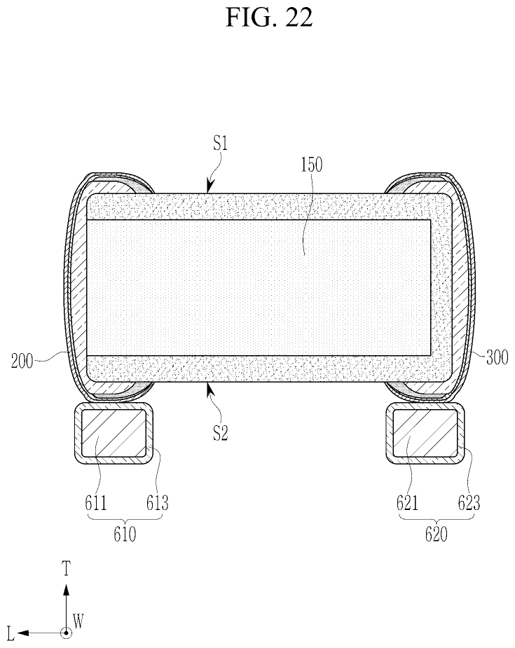

FIG. 21 illustrates a perspective view schematically showing a modified example of FIG. 16, and FIG. 22 illustrates schematic cross-sectional view of FIG. 21.

Referring to FIG. 21 and FIG. 22, the multilayer ceramic capacitor 3001 may include a body 110, a first external electrode 200, a second external electrode 300, and a bump electrode 600. The body 110 may include a plurality of dielectric layers 140, a first cover layer 143, a second cover layer 145, a first internal electrode 150, and a second internal electrode 160.

The first internal electrodes 150 and the second internal electrodes 160 may be stacked in the width direction (W-axis direction).

The remaining components are identical to the components of the multilayer ceramic capacitor shown in FIG. 16, so a repeated description thereof will be omitted.

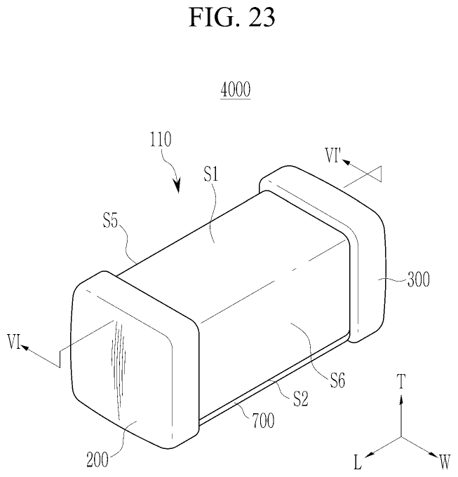

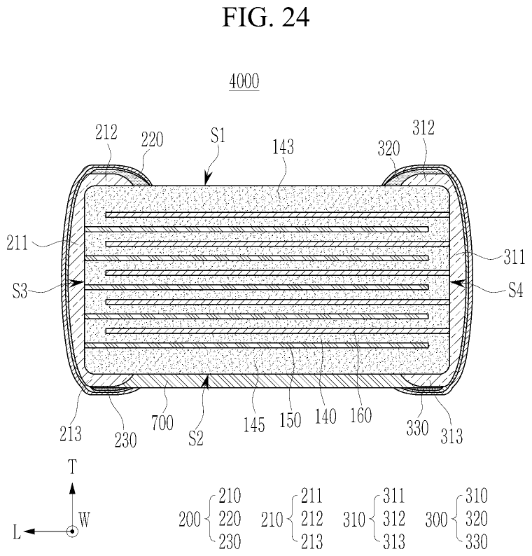

FIG. 23 illustrates a schematic perspective view showing a multilayer ceramic capacitor according to another embodiment, FIG. 24 illustrates a cross-sectional view taken along line VI-VI′ of FIG. 23.

Referring to FIG. 23 and FIG. 24, the multilayer ceramic capacitor 4000 may include a body 110, a first external electrode 200, a second external electrode 300, and an insulating resin layer 700.

The body 110 may include a plurality of dielectric layers 140, a first cover layer 143, a second cover layer 145, a first internal electrode 150, and a second internal electrode 160.

The insulating resin layer 700 may be disposed on the second surface S2 of the body 110, and may cover a portion of the second band portion 213 and a portion of the sixth band portion 313. Both ends of the insulating resin layer 700 in the length direction (L-axis direction) may be covered by the second conductive resin layer 230 and the sixth conductive resin layer 330, respectively. Accordingly, one end of the insulating resin layer 700 in the length direction (L-axis direction) may be disposed between the second band portion 213 and the second conductive resin layer 230, and the other end may be disposed between the sixth band portion 313 and the sixth conductive resin layer 330.

The insulating resin layer 700 may include an organic or inorganic material having a certain level of strength and moisture resistance. The aforementioned organic material may be at least one of epoxy or urethane, and the inorganic material may be at least one of silicon oxide (SiO₂) or titanium oxide (TiO).

The insulating resin layer 700 may absorb some of the vibrations generated in the multilayer ceramic capacitor 4000. Accordingly, acoustic noise may be reduced.

The remaining components are identical to the components of the multilayer ceramic capacitor shown in FIG. 1, so a repeated description thereof will be omitted.

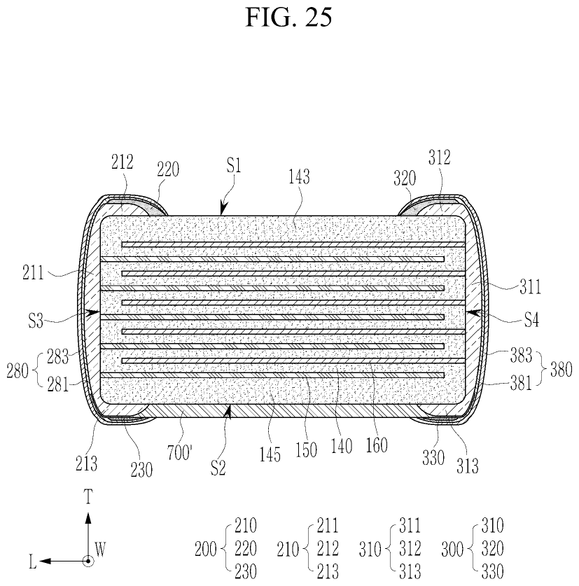

FIG. 25 illustrates a cross-sectional view schematically showing a modified example of FIG. 23.

Referring to FIG. 25, both ends of an insulating resin layer 700′ in the length direction (L-axis direction) may extend onto the first connection portion 211 and the second connection portion 311, respectively. In this case, one of the insulating resin layer 700′ in the length direction (L-axis direction) may be disposed between the first plating layer 280 and the first connection portion 211, and the other end may be disposed between the second plating layer 380 and the second connection portion 311.

The remaining components are identical to the components of the multilayer ceramic capacitor shown in FIG. 23, so a repeated description thereof will be omitted.

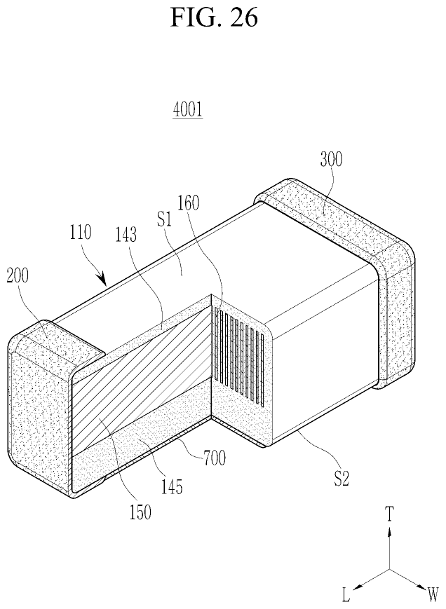

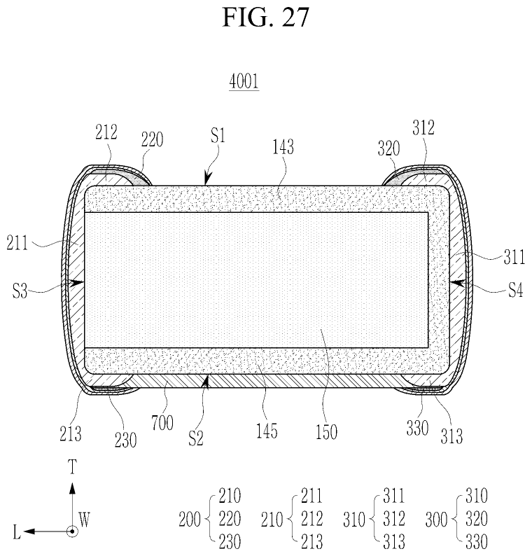

FIG. 26 illustrates a perspective view schematically showing a modified example of FIG. 23, and FIG. 27 illustrates a schematic cross-sectional view of FIG. 26.

Referring to FIG. 26 and FIG. 27, the multilayer ceramic capacitor 4001 may include a body 110, a first external electrode 200, a second external electrode 300, and an insulating resin layer 700. The body 110 may include a plurality of dielectric layers 140, a first cover layer 143, a second cover layer 145, a first internal electrode 150, and a second internal electrode 160.

The first internal electrodes 150 and the second internal electrodes 160 may be stacked in the width direction (W-axis direction).

The remaining components are identical to the components of the multilayer ceramic capacitor shown in FIG. 23, so a repeated description thereof will be omitted.

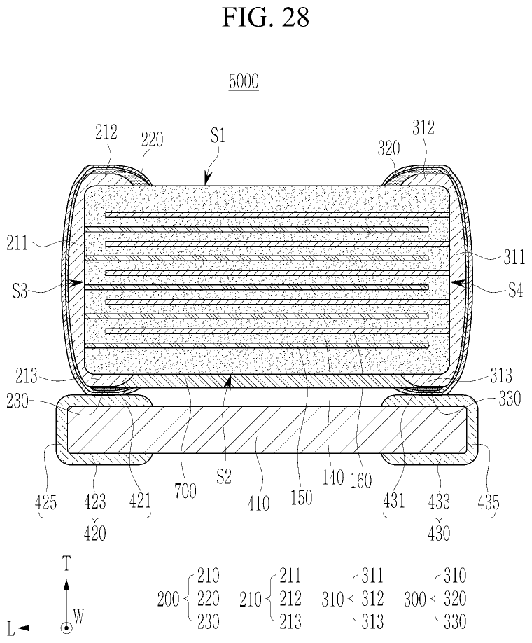

FIG. 28 illustrates a schematic cross-sectional view showing a multilayer ceramic capacitor according to another embodiment.

Referring to FIG. 28, the multilayer ceramic capacitor 5000 may include a body 110, a first external electrode 200, a second external electrode 300, an interposer 400, and an insulating resin layer 700. The body 110 may include a plurality of dielectric layers 140, a first cover layer 143, a second cover layer 145, a first internal electrode 150, and a second internal electrode 160.

The insulating resin layer 700 may be disposed on the second surface S2 of the body 110, and may cover a portion of the second band portion 213 and a portion of the sixth band portion 313. Both ends of the insulating resin layer 700 in the length direction (L-axis direction) may be covered by the second conductive resin layer 230 and the sixth conductive resin layer 330, respectively. Accordingly, one end of the insulating resin layer 700 in the length direction (L-axis direction) may be disposed between the second band portion 213 and the second conductive resin layer 230, and the other end may be disposed between the sixth band portion 313 and the sixth conductive resin layer 330.

For example, the insulating resin layer 700 may be spaced apart from the interposer 400 in the thickness direction (T-axis direction).

The insulating resin layer 700 may include an organic or inorganic material having a certain level of strength and moisture resistance. The aforementioned organic material may be at least one of epoxy or urethane, and the inorganic material may be at least one of silicon oxide (SiO₂) or titanium oxide (TiO).

The insulating resin layer 700 may absorb some of the vibrations generated in the multilayer ceramic capacitor 5000. Accordingly, acoustic noise may be reduced.

The components, except for the insulating resin layer 700, are the same as those of the multilayer ceramic capacitor shown in FIG. 12, so a repeated description thereof will be omitted.

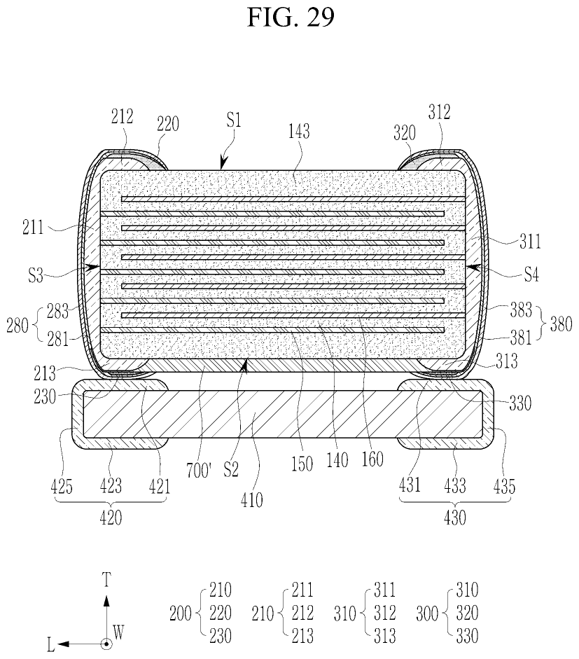

FIG. 29 illustrates a cross-sectional view schematically showing a modified example of FIG. 28.

Referring to FIG. 29, both ends of an insulating resin layer 700′ in the length direction (L-axis direction) may extend onto the first connection portion 211 and the second connection portion 311, respectively. In this case, one end of the insulating resin layer 700′ in the length direction (L-axis direction) may be disposed between the first plating layer 280 and the first connection portion 211, and the other end may be disposed between the second plating layer 380 and the second connection portion 311.

The remaining components are identical to the components of the multilayer ceramic capacitor shown in FIG. 28, so a repeated description thereof will be omitted.

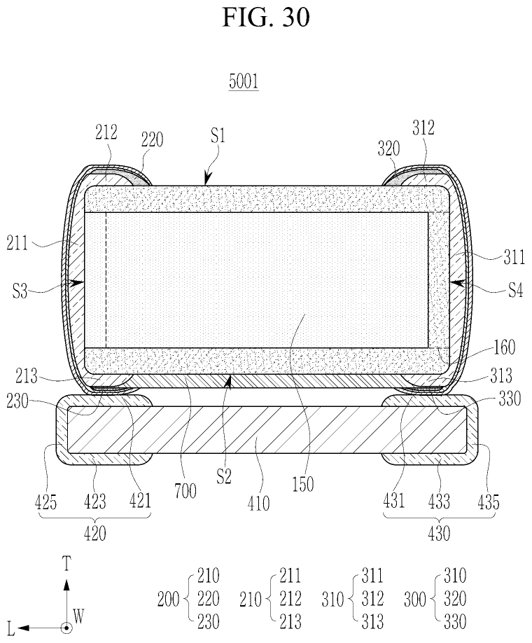

FIG. 30 illustrates a cross-sectional view schematically showing a modified example of FIG. 28.

Referring to FIG. 30, the multilayer ceramic capacitor 5001 may include a body 110, a first external electrode 200, a second external electrode 300, an interposer 400, and an insulating resin layer 700. The body 110 may include a first internal electrode 150, and a second internal electrode 160.

The first internal electrodes 150 and the second internal electrodes 160 may be stacked in the width direction (W-axis direction).

The remaining components are identical to the components of the multilayer ceramic capacitor shown in FIG. 28, so a repeated description thereof will be omitted.

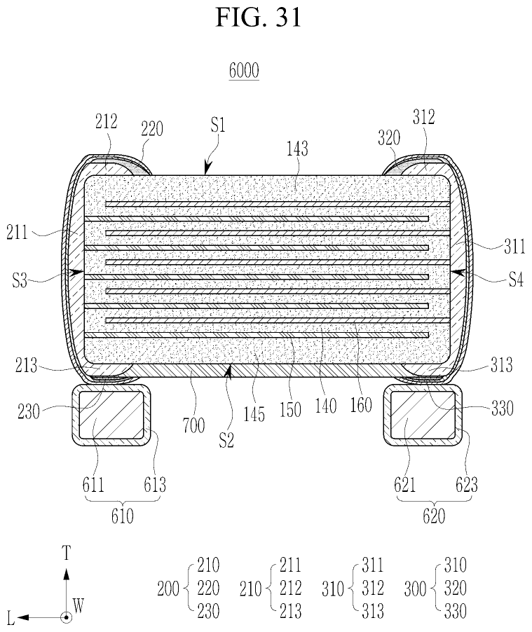

FIG. 31 illustrates a schematic cross-sectional view showing a multilayer ceramic capacitor according to another embodiment.

Referring to FIG. 31, the multilayer ceramic capacitor 6000 may include a body 110, a first external electrode 200, a second external electrode 300, a bump electrode 600, and an insulating resin layer 700. The body 110 may include a plurality of dielectric layers 140, a first cover layer 143, a second cover layer 145, a first internal electrode 150, and a second internal electrode 160.

The insulating resin layer 700 may be disposed on the second surface S2 of the body 110, and may cover a portion of the second band portion 213 and a portion of the sixth band portion 313. Both ends of the insulating resin layer 700 in the length direction (L-axis direction) may be covered by the second conductive resin layer 230 and the sixth conductive resin layer 330, respectively. Accordingly, one end of the insulating resin layer 700 in the length direction (L-axis direction) may be disposed between the second band portion 213 and the second conductive resin layer 230, and the other end may be disposed between the sixth band portion 313 and the sixth conductive resin layer 330.

The insulating resin layer 700 may include an organic or inorganic material having a certain level of strength and moisture resistance. The aforementioned organic material may be at least one of epoxy or urethane, and the inorganic material may be at least one of silicon oxide (SiO₂) or titanium oxide (TiO).

The insulating resin layer 700 may absorb some of the vibrations generated in the multilayer ceramic capacitor 6000. Accordingly, acoustic noise may be reduced.

The components, except for the insulating resin layer 700, are the same as those of the multilayer ceramic capacitor shown in FIG. 16, so a repeated description thereof will be omitted.

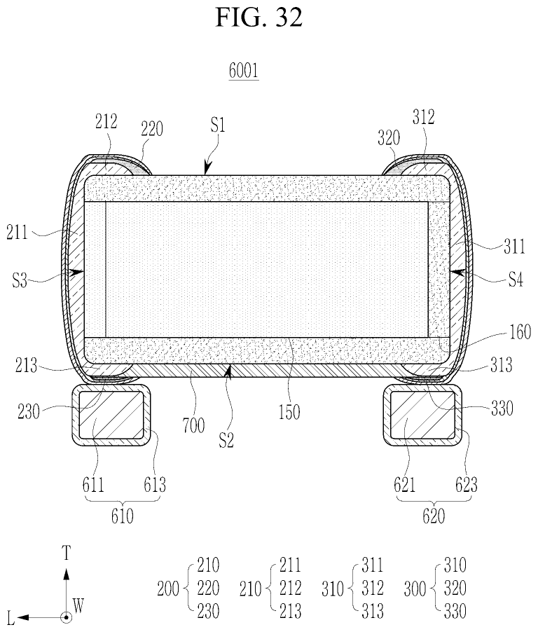

FIG. 32 illustrates a cross-sectional view schematically showing a modified example of FIG. 31.

Referring to FIG. 32, the multilayer ceramic capacitor 6001 may include a body 110, a first external electrode 200, a second external electrode 300, a bump electrode 600, and an insulating resin layer 700. The body 110 may include a first internal electrode 150, and a second internal electrode 160.

The first internal electrodes 150 and the second internal electrodes 160 may be stacked in the width direction (W-axis direction).

The remaining components are identical to the components of the multilayer ceramic capacitor shown in FIG. 31, so a repeated description thereof will be omitted.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor comprising:
a body comprising a first surface and a second surface opposite each other in a first direction, a plurality of dielectric layers and a plurality of internal electrodes, a first cover layer disposed at an outermost side in the first direction, and a second cover layer disposed opposite the first cover layer in the first direction and having an average thickness that is greater than an average thickness of the first cover layer; and
an external electrode disposed outside the body and connected to the plurality of internal electrodes,
wherein the external electrode includes:
a connection portion connected to the plurality of internal electrodes in a second direction different from the first direction;
a first band portion connected to the connection portion and covering a portion of the first surface;
a second band portion connected to the connection portion and covering a portion of the second surface;
a first conductive resin layer disposed on the first band portion;
a second conductive resin layer disposed on the second band portion; and
a plating layer connected to the connection portion and covering the first conductive resin layer and the second conductive resin layer.

2. The multilayer ceramic capacitor of claim 1, further comprising
an insulating resin layer covering a portion of the second surface of the body.

3. The multilayer ceramic capacitor of claim 2, wherein
the insulating resin layer covers a portion of the second band portion, and
the second conductive resin layer covers a portion of the insulating resin layer.

4. The multilayer ceramic capacitor of claim 2, wherein
the insulating resin layer includes epoxy, urethane, silicon oxide (SiO₂), or titanium oxide (TiO).

5. The multilayer ceramic capacitor of claim 1, wherein
the plurality of dielectric layers and the plurality of internal electrodes are stacked in the first direction.

6. The multilayer ceramic capacitor of claim 1, wherein
the plurality of dielectric layers and the plurality of internal electrodes are stacked in a third direction different from both the first direction and the second direction.

7. The multilayer ceramic capacitor of claim 1, wherein
the first conductive resin layer and the second conductive resin layer each include a metal and a resin.

8. A multilayer ceramic capacitor comprising:
a body comprising a first surface and a second surface opposite each other in a first direction, a plurality of dielectric layers, and a plurality of internal electrodes;
an external electrode disposed outside the body and connected to the plurality of internal electrodes; and
an interposer connected to the external electrode on a second surface side of the body,
wherein the external electrode includes:
a connection portion connected to the plurality of internal electrodes in a second direction different from the first direction;
a first band portion connected to the connection portion and covering a portion of the first surface;
a second band portion connected to the connection portion and covering a portion of the second surface;
a first conductive resin layer disposed on the first band portion;
a second conductive resin layer disposed on the second band portion; and
a plating layer connected to the connection portion and covering the first conductive resin layer and the second conductive resin layer.

9. The multilayer ceramic capacitor of claim 8, wherein
the interposer includes:
an interposer body; and
a connection electrode disposed outside the interposer body and connected to the external electrode.

10. The multilayer ceramic capacitor of claim 9, wherein
the interposer body includes an insulating material.

11. The multilayer ceramic capacitor of claim 9, wherein
the interposer body includes:
a first main surface opposing the second surface of the body; and
a second main surface disposed opposite the first main surface in the first direction,
wherein the connection electrode includes a joint portion disposed on the first main surface.

12. The multilayer ceramic capacitor of claim 11, wherein
the connection electrode includes a mounting portion disposed on the second main surface.

13. The multilayer ceramic capacitor of claim 12, wherein
the connection electrode includes an interconnecting portion connecting the joint portion and the mounting portion.

14. The multilayer ceramic capacitor of claim 8, further comprising:
an insulating resin layer covering a portion of the second surface of the body.

15. The multilayer ceramic capacitor of claim 14, wherein
the insulating resin layer is spaced apart from the interposer.

16. The multilayer ceramic capacitor of claim 14, wherein
the insulating resin layer includes epoxy, urethane, silicon oxide (SiO₂), or titanium oxide (TiO).

17. The multilayer ceramic capacitor of claim 8, wherein
the plurality of dielectric layers and the plurality of internal electrodes are stacked in the first direction.

18. The multilayer ceramic capacitor of claim 8, wherein
the plurality of dielectric layers and the plurality of internal electrodes are stacked in a third direction different from both the first direction and the second direction.

19. A multilayer ceramic capacitor comprising:
a body comprising a first surface and a second surface opposite each other in a first direction, a plurality of dielectric layers, and a plurality of internal electrodes;
an external electrode disposed outside the body and connected to the plurality of internal electrodes; and
a bump electrode connected to the external electrode on a second surface side of the body,
wherein the external electrode includes:
a connection portion connected to the plurality of internal electrodes in a second direction different from the first direction;
a first band portion connected to the connection portion and covering a portion of the first surface;
a second band portion connected to the connection portion and covering a portion of the second surface;
a first conductive resin layer disposed on the first band portion;
a second conductive resin layer disposed on the second band portion; and
a plating layer connected to the connection portion and covering the first conductive resin layer and the second conductive resin layer.

20. The multilayer ceramic capacitor of claim 19, wherein
the body includes a third surface and a fourth surface opposite each other in the second direction,
the external electrode includes a first external electrode connected to the plurality of internal electrodes on the third surface and a second external electrode connected to the plurality of internal electrodes on the fourth surface, and
the bump electrode includes a first bump electrode connected to the first external electrode, and a second bump electrode spaced apart from the first bump electrode in the second direction and connected to the second external electrode.

21. The multilayer ceramic capacitor of claim 19, wherein
the bump electrode includes a bump body and a conductive layer disposed on a surface of the bump body and connected to the external electrode.

22. The multilayer ceramic capacitor of claim 21, wherein
the bump body includes a metal or an insulating material.

23. The multilayer ceramic capacitor of claim 19, further comprising:
an insulating resin layer covering a portion of the second surface of the body.

24. The multilayer ceramic capacitor of claim 19, wherein
the plurality of dielectric layers and the plurality of internal electrodes are stacked in the first direction.

25. The multilayer ceramic capacitor of claim 19, wherein
the plurality of dielectric layers and the plurality of internal electrodes are stacked in a third direction different from both the first direction and the second direction.

26. The multilayer ceramic capacitor of claim 1, wherein
the second direction intersects the first direction.

27. The multilayer ceramic capacitor of claim 6, wherein
the third direction intersects both the first direction and the second direction.

28. The multilayer ceramic capacitor of claim 8, wherein
the second direction intersects the first direction.

29. The multilayer ceramic capacitor of claim 18, wherein
the third direction intersects both the first direction and the second direction.

30. The multilayer ceramic capacitor of claim 19, wherein
the second direction intersects the first direction.

31. The multilayer ceramic capacitor of claim 25, wherein
the third direction intersects both the first direction and the second direction.
